(19) United States
(12) Patent Application Publication
(10) Pub. No.: US 2002/0110002 A1
(43) Pub. Date: Aug. 15, 2002

(54) Fiber optic lighting system and method of use

(76) Inventor: Dennis Lee Nelson, Oakharbor, WA (US)

Correspondence Address: DENNIS LEE NELSON, 695 E MAPLEWOOD LOOP, OAKHARBOR, WA, 98277, US

(21) Appl. No.: 10/057,077

(22) Filed: Jan. 23, 2002

Related U.S. Application Data
(60) Provisional application No. 60/264,484, filed on Jan. 26, 2001.

(51) Int. Cl. F21S 4/00

(52) U.S. Cl. 362/567

(57) ABSTRACT

This invention pertains generally to lighting decorations for structures such as homes, boats condo's or buildings. It is a modular fiber optic lighting system, which will be easily installed and can change themes for different holidays or occasions. It will be more energy efficient and safer than anything on the market today, with a more precise color changes and fewer light bulbs to change. It gives the owner more options of decoration than anyone system on the market, and can be used indoors or outdoors without the fear of fire because the fiber cables do not get hot or have any electrical wiring in them. The invention will also be available in many different sizes and designs so the owners can custom fit the system to how they want it to look.

### TECHNICAL FIELD

The present invention pertains generally to lighting decorations for structures such as homes, boats condo's and buildings.

And more particularly to a modular fiber optic lighting system, which is easily mounted and can be readily changed to display different themes.

### BACKGROUND ART

Decorative lights are well known in the art. Particularly at Christmas time, homes, buildings, and even vegetation is strung with a variety of decorative lights.

This process usually consists of mounting the strings of incandescent lights on the house or building, using the lights during the holiday season, and then removing and storing the strings of lights. The mounting and removal of the strings of lights can be a labor intensive and time consuming process.

Also, the lights can constitute a fire hazard, or an electrical shock may occur.

### SUMMARY OF THE INVENTION

The present invention is directed to a modular fiber optic lighting system, which well adapted for use on houses, buildings or other structures. The system is divided into several parts which include an illuminator or light source, a plurality of main fiber optic cables and a plurality of different umbrella end fiber optic cable assemblies.

Each umbrella end fiber optic cable has light emitting decorations, which portray a particular theme. For example, a Christmas theme might include Santa's, candy canes, reindeer and the like. The umbrella end fiber optic cable assemblies can be quickly changed to portray a different theme.

Purpose—The fiber optic lighting system of the present invention is safer than anything on the market, will take less power and will lesson the chance for fire to the home.

Parts—the parts vary in each application, for every home is different and not every homeowner will want the same package. A main part of the fiber optic lighting system is the light source which is called an illuminator or fusion pump, and which is produced by Boston fiber optics.

The illuminator is available with color on command and an on board intelligent control option, offering three methods of color control. First manual control allows the customer or user to operate the color wheels from the touch panel for infrequent color changes. The user will also have the option to have preprogrammed cues that offer a variety of optional color sequences including standard and theatrical lighting systems. If more than one illuminator is needed in the application, then they can be synchronized to cues on a master illuminator by simply connecting them with the control cables, which will allow the user to create programmed sequential color changes.

There are different types of fiber optic cable used, the first is the Opti-Mega fiber which is a 14 mm solid core fiber used to carry the light from the illuminator to the umbrella end connectors. The schematic shows eight 14 mm cables from the illuminator, four cables 2.1 inches wide and 0.55 inches thick will go in one direction and the other four cables will travel in the other direction, down to the umbrella connectors this is called the main line of the fiber optic cabling. The illuminator is mounted under the eves of the home or structure and the fiber optic cables will split and four cables will go in one direction down the eves and the other four cables will travel in the other direction down the eves, this is called the main line.

The main line consists of eight 14 mm fiber optic cables, one of the four cables is five feet long, the second cable is fifteen feet long and the third cable is twenty-five feet long, the fourth cable is thirty-five feet long. The other four cables of the main line is the same dimensions, but will travel in the other direction. Each cable has a connector on the end, this is called the umbrella end connector which will connect the main line to the umbrella ends. The main cables from the illuminator to the umbrella connectors is called the main line, which can be left up all year round with rubber boots covering the connectors and the ends of the cables to keep out any contamination.

The second type of fiber optic cable used is called HiLite, this cable has many single fibers inside the plastic cover as shown in the description pages. This cable is used in the umbrella ends, each umbrella end covers 10 ft across.

From the connector the cable goes five inches and then splits, with half of the cable going left and the other half going right. Each side is 7 ft long and branches off two more times about 1 ft-6 inches apart, so you will have three lines that hang down on each side of the umbrella that are about 20 inches in length. The six lines that hang down on the umbrella will also branch off four times on each line about 2 to 4 inches apart as shown in the diagrams.

The cables that branch off are 6 inches in length and in some applications they will have a decorative design connected to the end of the cables. The decorations will be 2 inches in diameter and will light up, they will also change color with the illuminator. The decorations that will be available are stars, pumpkins, snowflakes and hearts, there will be more decorations to come later.

The third type of fiber optic cable used is called Super-Twist, and in my application it is called Neon Ice. The Neon Ice is configured the same as the other applications with the exception that it is a side emitting fiber optic cable, which means that it lights up just like neon lighting and changes color with the illuminator. All the fiber optic cable is produced by Boston Fiber Optics as shown in the following pages of this disclosure. The total coverage with all the umbrella ends in place with this application is 40 feet in both directions, a total of 80 feet of lighting with one illuminator. Some applications may take multiple illuminators to get the effect the homeowner will want, some applications will take less like for condos and such.

The other application is installed in the attic of the home. With only the 14 mm cables extending out through the vent holes, with umbrella connectors on the end of the cables, so all the home owner will have to do is put up the umbrella ends and there lights are in place. In some applications if the home has soffits or vinyl siding the homeowner will have to customize the application. It may be appreciated that the recited lengths and size of fiber optic cable may be changed to accommodate a variety of lighting applications.

Novel Features—The present invention includes the following novel features:

The present invention can be used for more than one holiday or special occasion.

It is easy to install on the home temporary or permanently, and the connections on the fiber optic cables are very easy to use.

The illuminators all have a watertight seal, and they also have color control systems built in.

The fiber optic cables will not get hot or short out, or cause an electrical fire and can operate in cold or hot temperatures and even in the rain without any problems.

Only one light bulb is used for up to an 80ft section of lighting, depending on the application.

This product is safer than anything on the market today and saves on power usage.

Color changes are more precise than anything available today.

All the fiber optic cabling has UV protection and will last a very long time.

This system has more themes than any other system on the market.

Advantages—The present invention greatly reduces the risk of fire to the home. It is easy to use and the fiber cable will not get hot. Once the fiber optic cable is installed on the home it is easy to put the lights up in a very short time.

Changing from one occasion to another is fast and easy, all that is needed is to change the umbrella ends or the decorations. The present invention is energy efficient and is safer for the homeowner. Has more options and a more accurate color changes.

### DETAILED DESCRIPTION OF THE INVENTION

Referring initially to FIG. 1, There is illustrated a schematic diagram of a fiber optic lighting system 20 includes (1) an illuminator 22 for emitting light, and which is programmable to output a plurality of lighting effects such as different colors, sequenced illumination, and the like. (2) A plurality of main fiber optic cables 24 having a first end 26 and an opposite second end 28, each first end 26 connected to illuminator 22, which are removable. (3) A corresponding plurality of umbrella connectors 30 wherein one umbrella connector 30 is connected to second end 28 of each main fiber optic cable 24. (4) A corresponding plurality of umbrella end fiber optic cables 32 wherein the umbrella end fiber optic cable 32, is selectively connectable to the umbrella connector 30. When illuminator 22 emits light the light travels through the plurality of main fiber optic cables 24, to the plurality of umbrella end fiber optic cables 32. Main fiber optic cable 24 is selectively connected to illuminator 22 at first end 26.

FIG. 2 is an upward looking view of fiber optic system 20 installed under the eves of the structure in the outside application. Illuminator 22 is mounted under the eves of the structure, the main cable 24 is shown with four cables going one direction down the eves, and the other four cables going the other direction, terminating with the umbrella ends 30 on all cable ends. In one preferred embodiment, main fiber optic cable 24 with umbrella to connectors 30 can be permanently attached to the structure. Thereby greatly lessening the installation time after installation.

FIG.3 is a side elevation view of fiber optic lighting system 20 installed in the attic of a structure in an attic application. And FIG. 4 is an upward looking view of the fiber optic system installed under the eves of the structure in the attic application. In this application illuminator 22, main fiber optic cables 24, and umbrella connectors 30 are all permanently installed on the structure. All then that is needed to effect a lighting display is to connect the umbrella end fiber optic cables 32 to the umbrella connectors 30 and turn on the illuminator 22.

FIG. 5 is a sheet describing Opti-Mega fiber optic cable.

FIG.6 is a sheet describing Hi-Light fiber optic cable.

FIG. 7 is a sheet describing Super Twist fiber optic cable.

FIG. 8 is a pumpkin umbrella end fiber optic cable 32. Umbrella end fiber optic cable 32 includes a plurality of tree-like branches 38, which terminate in a light emitting decorations 40 which represent a predetermined theme such as for a holiday. The umbrella end fiber optic cables 32 can be easily changed as dictated by the occasion or holiday.

FIG. 9 is a Halloween umbrella end fiber optic cable 32.

FIG. 10 is a snowflake umbrella end fiber optic cable 32.

FIG. 11 is a stars umbrella end fiber optic cable 32.

FIG. 12 is a heart umbrella end fiber optic cable 32.

FIG. 13 is a Neon Ice umbrella end fiber optic cable 32. The Neon Ice type cable does not terminate in a light emitting decoration, but rather the branches 38 of the cable all illuminate like a neon tube.

Other features and advantages of the present invention will become more apparent from the accompanying drawings, which illustrate, by way of example, the principles of the invention. The preferred embodiments of the invention described herein are exemplary and numerous modifications, dimensional variations, and rearrangements can be readily envisioned to achieve an equivalent result, all of which are intended to be embraced within the scope of the appended claims.

### BRIEF DESCRIPTION OF DRAWINGS

FIG. 1 is a schematic diagram of a fiber optic lighting system in accordance with the present invention.

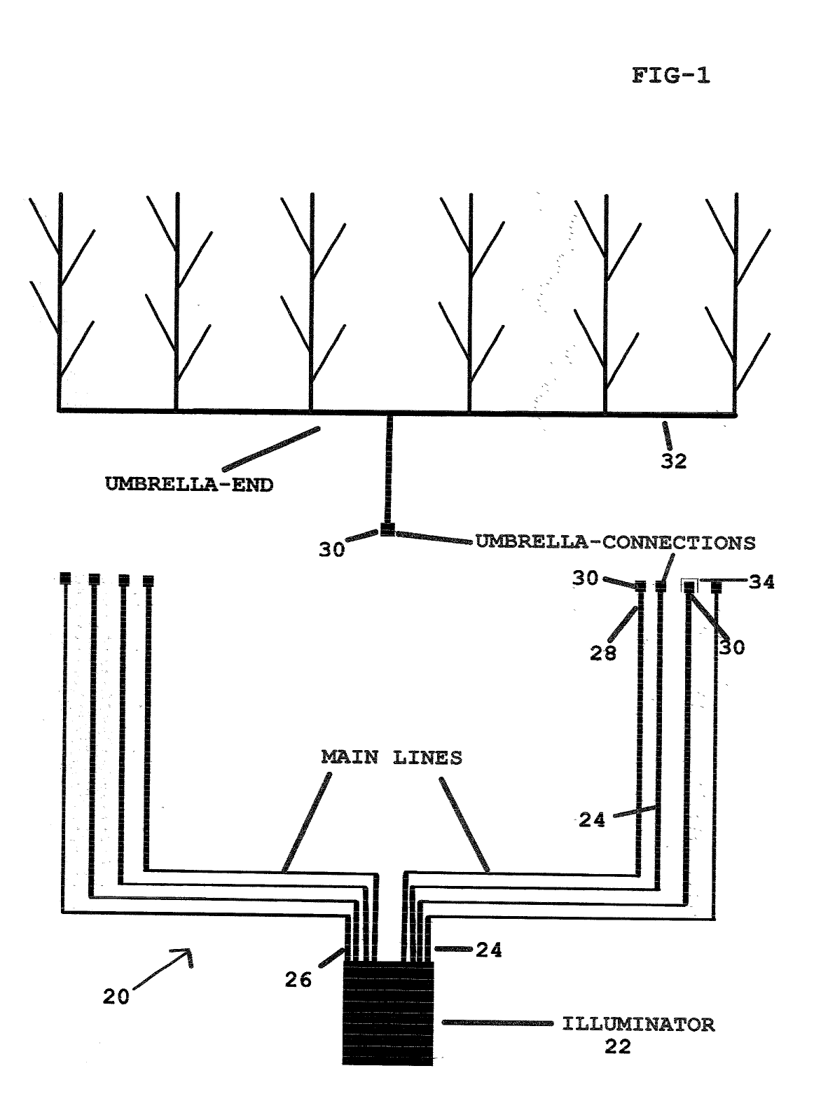

FIG. 2 is an upward looking view of the fiber optic system installed under the eves of the structure in the outside application.

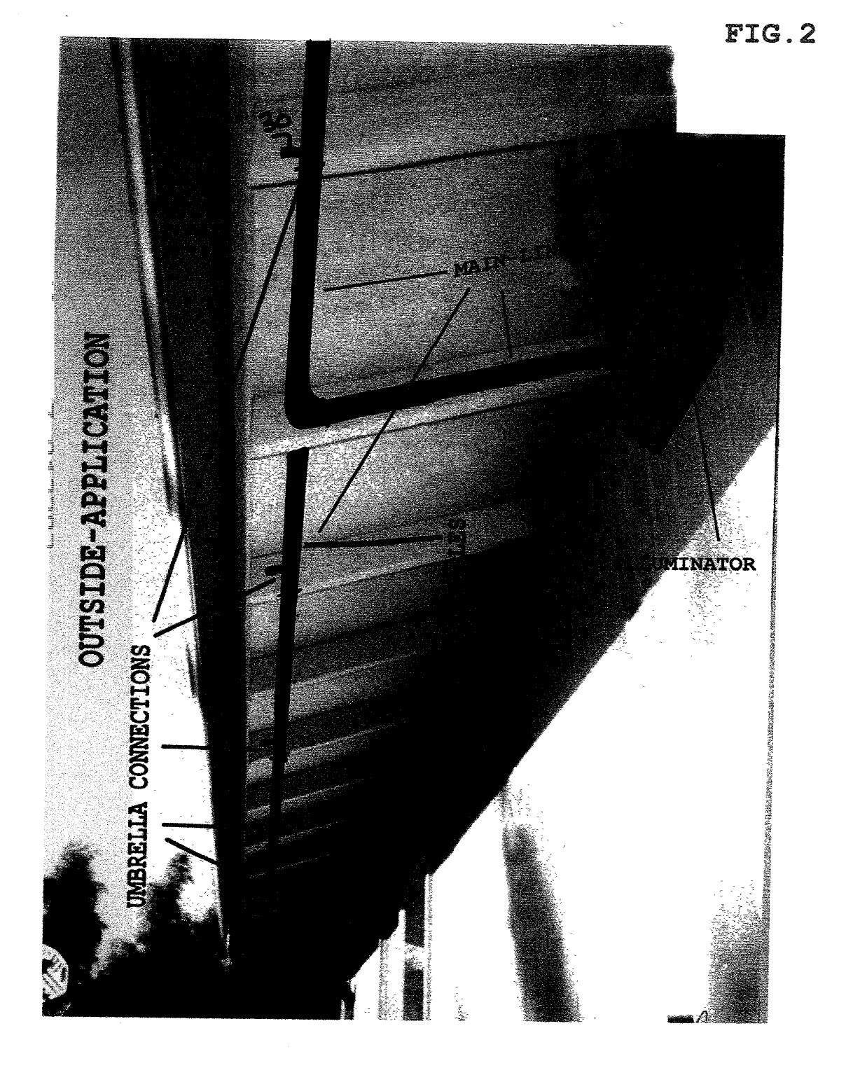

FIG. 3 is a side elevation view of the fiber optic lighting system installed in the attic of a structure in an attic application.

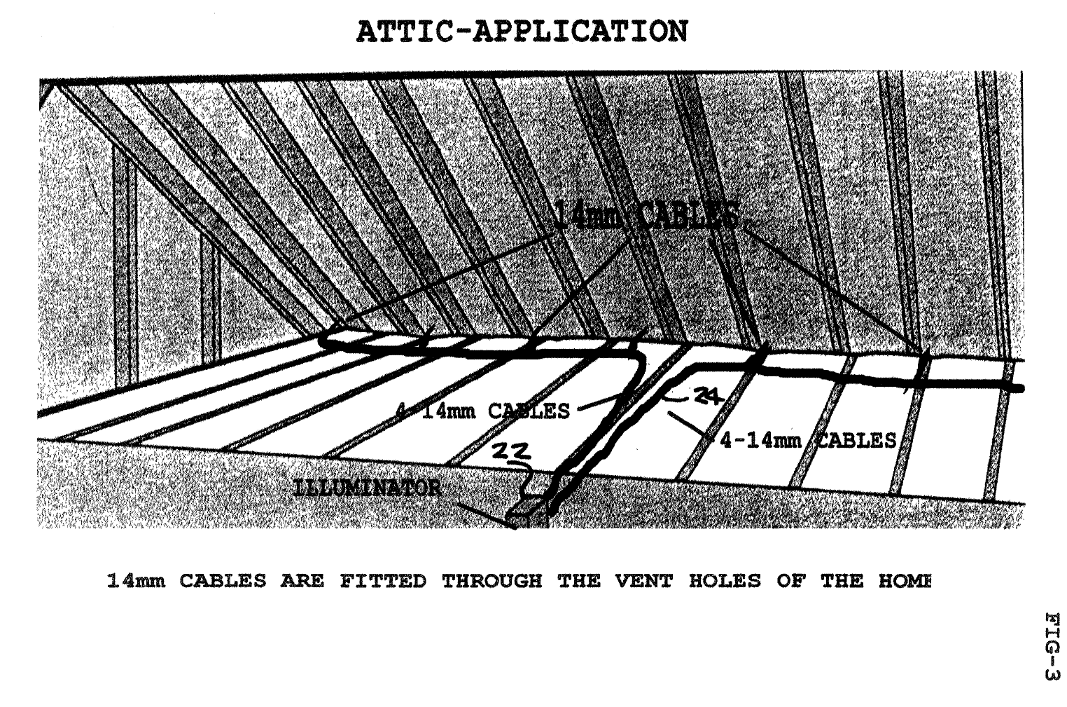

FIG. 4 is an upward looking view of the fiber optic lighting system installed in the eves of the structure in the attic application showing the umbrella end fiber optic cable hanging out from under the eves of the structure.

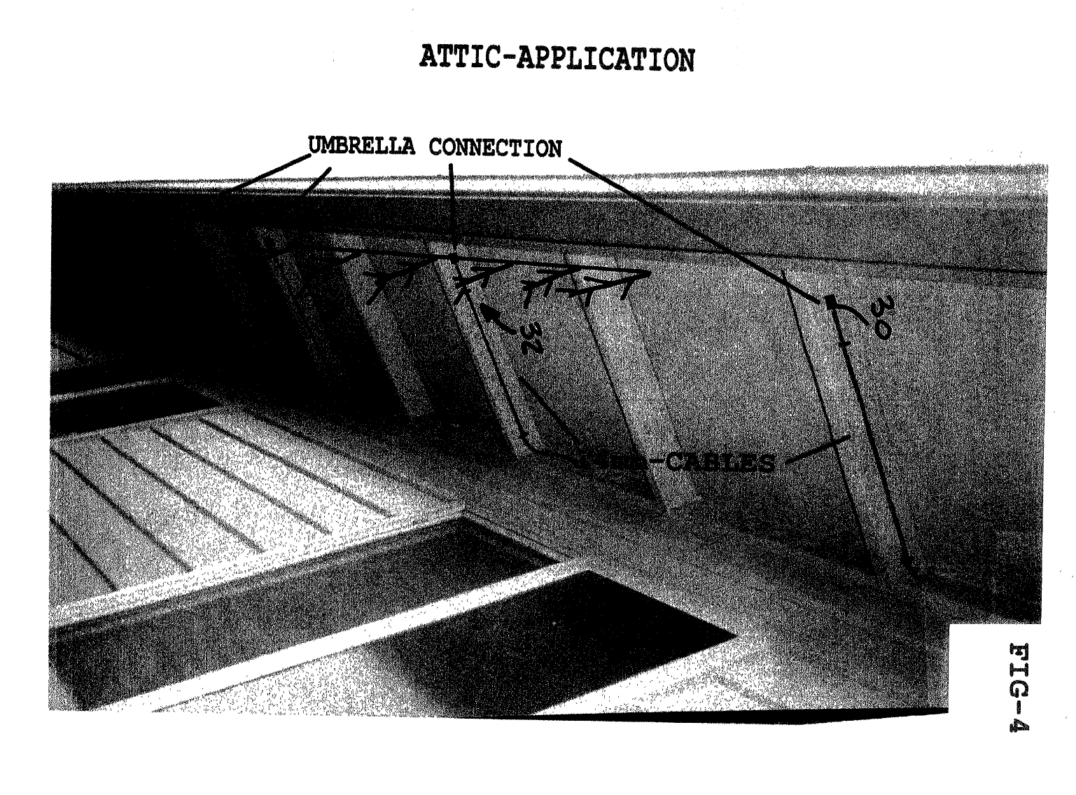

FIG. 5 is a sheet describing Opti-Mega fiber optic cable.

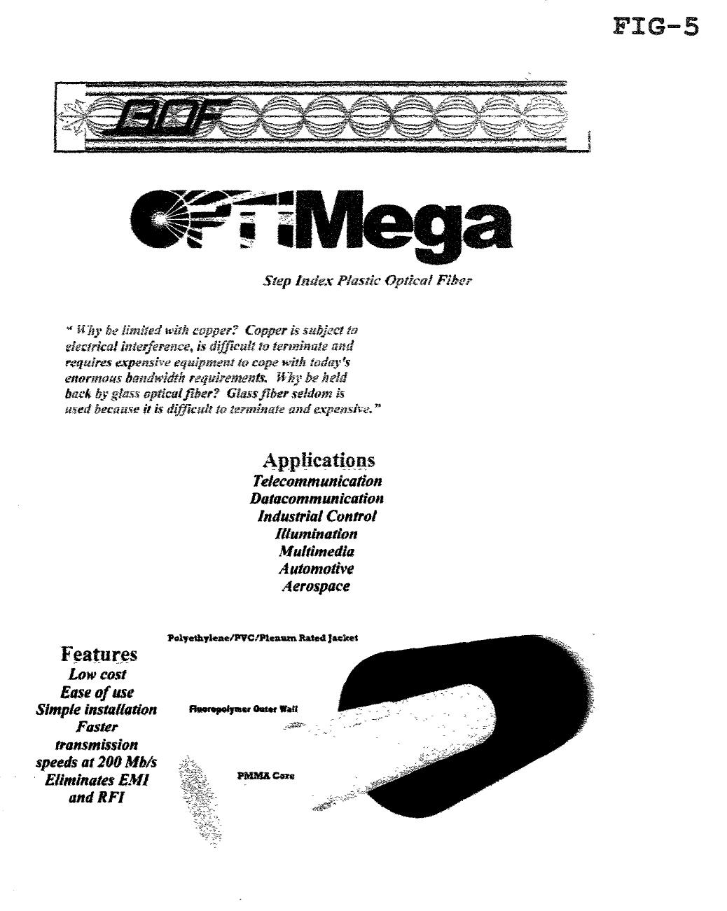

FIG. 6 is a sheet describing Hi-Lite fiber optic cable.

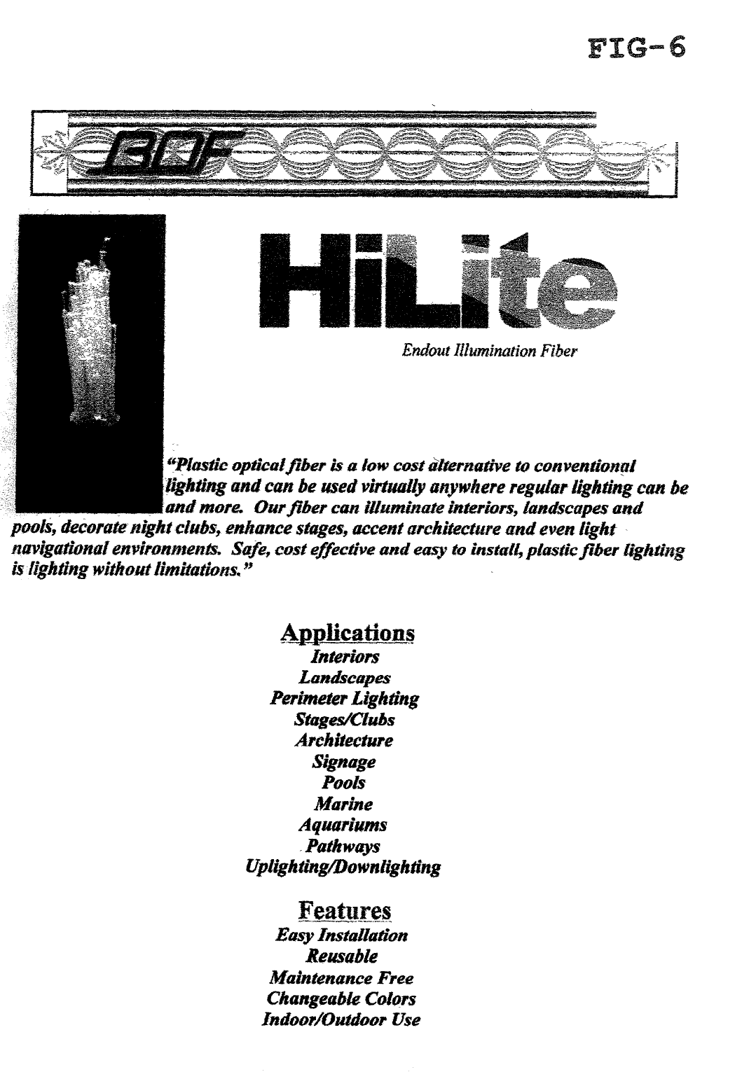

FIG. 7 is a sheet describing Super Twist fiber optic cable.

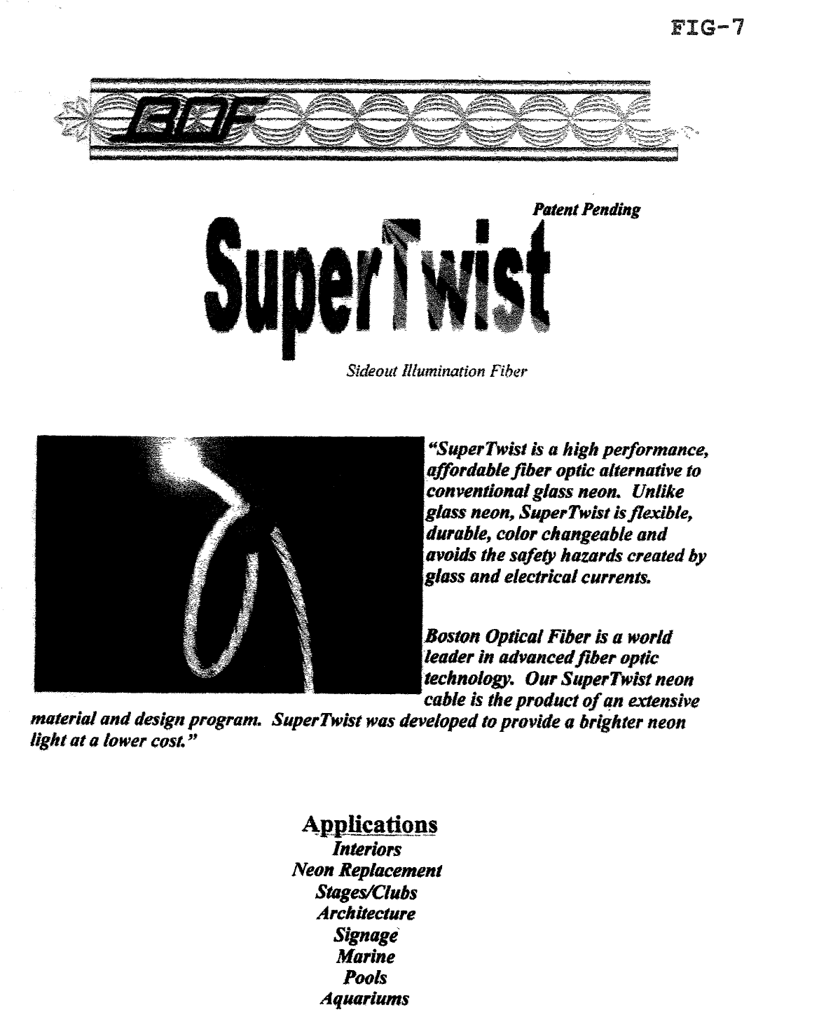

FIG. 8 is a pumpkin umbrella end fiber optic cable.

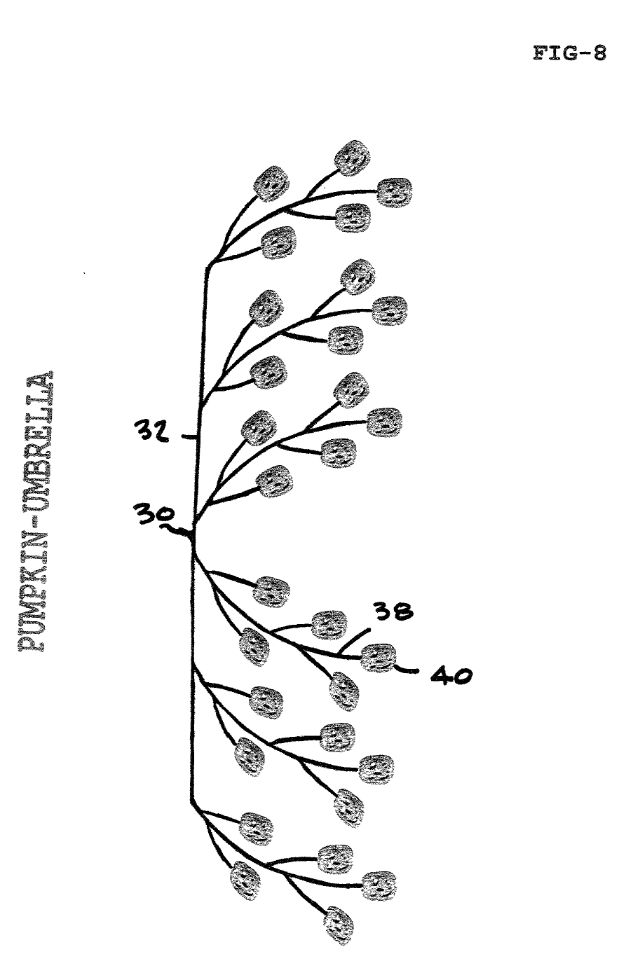

FIG. 9 is a Halloween umbrella end fiber optic cable.

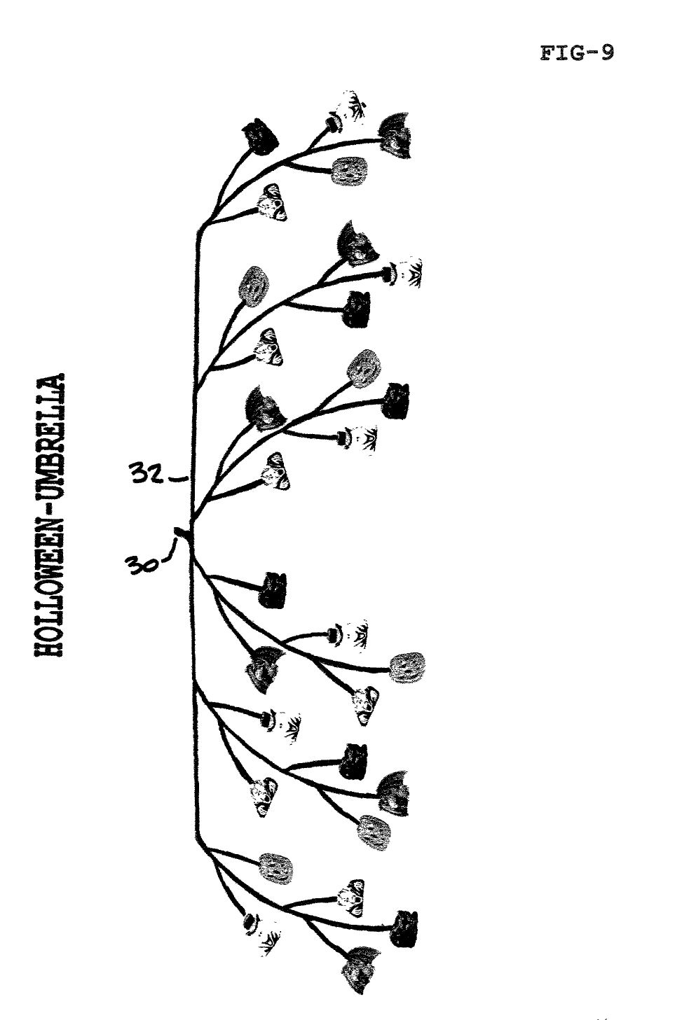

FIG. 10 is a snowflake umbrella end fiber optic cable.

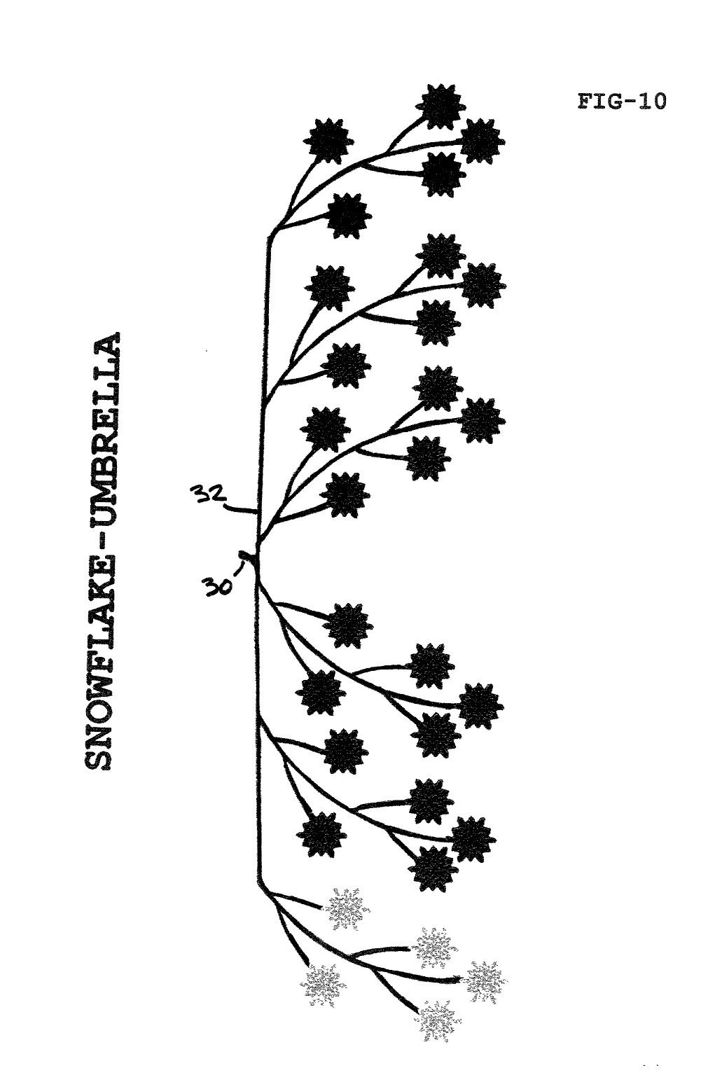

FIG. 11 is a stars umbrella end fiber optic cable.

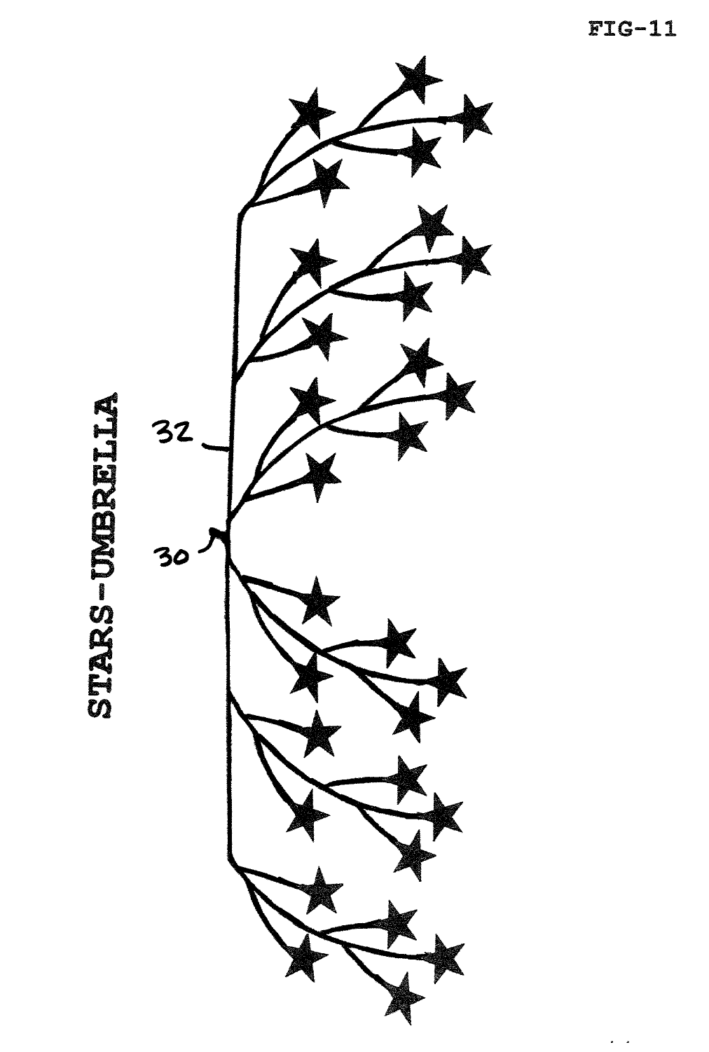

FIG. 12 is a hearts umbrella end fiber optic cable.

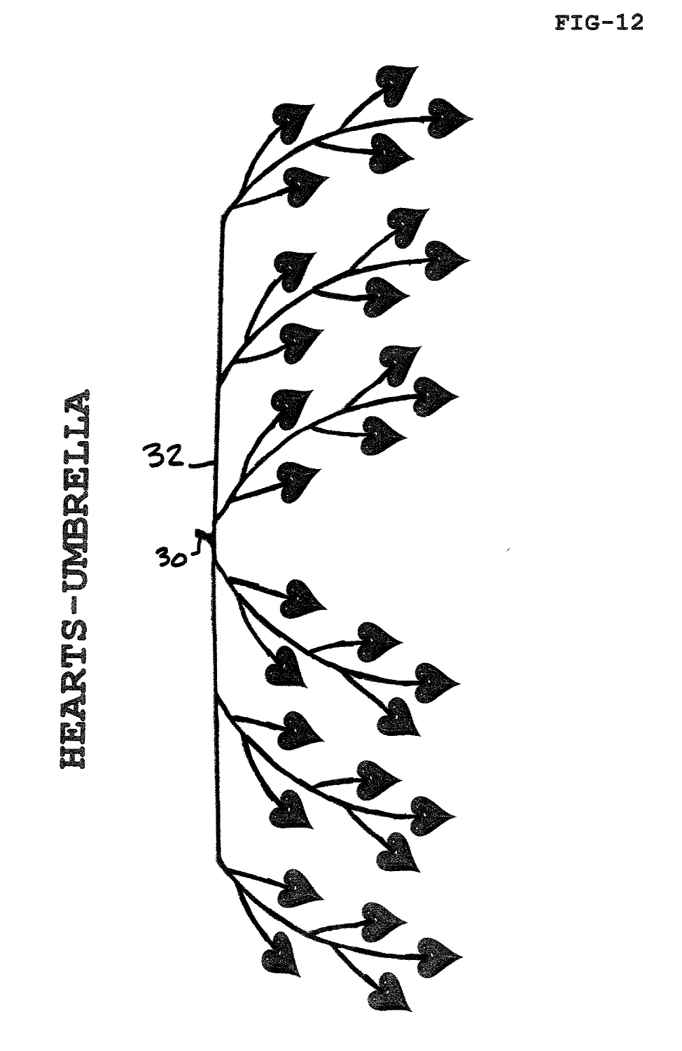

FIG. 13 is a Neon Ice umbrella end fiber optic cable.

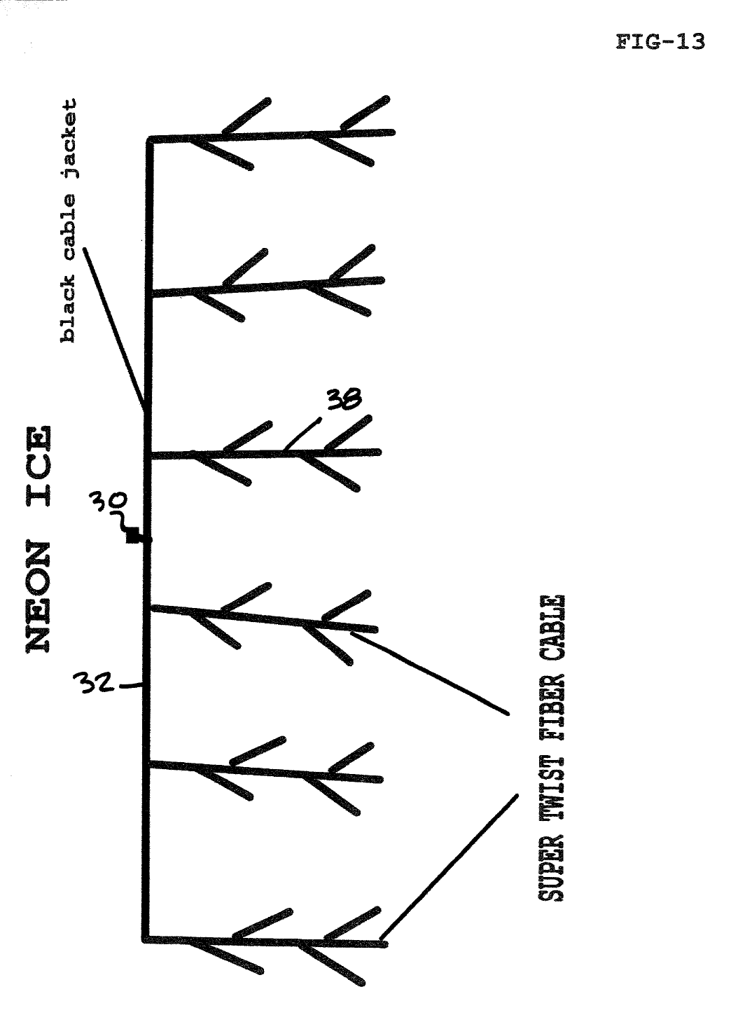

I claim:

1. A fiber optic lighting system, comprising:
An illuminator for emitting light;
A plurality of main fiber optic cables having a first end and an opposite second end, each said first end connected to said illuminator;
A corresponding plurality of umbrella connectors wherein one said umbrella connector is connected to said second end of each said main fiber optic cable;
A corresponding plurality of umbrella end fiber optic cables wherein said umbrella end fiber optic cable is connectable to said umbrella connector;
And so that when said illuminator emits light, said light travels through said plurality of main fiber optic cables to said plurality of umbrella end fiber optic cables.

2. A fiber optic lighting system according to claim 1, further including:
Said main fiber optic cable selectively connected to said illuminator.

3. A fiber optic lighting system according to claim 1, further including:
A rubber boot for covering said umbrella end connectors when not in use.

4. A fiber optic lighting system according to claim 1, further including:
Said umbrella end fiber optic cables are selectively attachable to said umbrella connectors.

5. A fiber optic lighting system according to claim 1, further including:
Said illuminator programmable to output a plurality of lighting effects.

6. A fiber optic lighting system according to claim 1, further including:
Said umbrella end fiber optic cable including a plurality of tree-like branches.

7. A fiber optic lighting system according to claim 1, further including:
Said tree-like branches terminating in a light emitting decoration:

8. A fiber optic lighting system according to claim 1, further including:
Said umbrella end fiber optic cable including light emitting decorations Which represent a predetermined theme.

9. A fiber optic lighting system according to claim 1, further including:
Permanently attaching said main fiber optic cable and said umbrella end connectors to a structure.

10. A fiber optic lighting system according to claim 1, further including:
A plurality of fiber optic connectors disposed along said plurality of main fiber optic cables between said illuminator and each said umbrella connector.

11. A fiber optic lighting system according to claim 1, further including:
Said plurality of umbrella connectors, and a portion of said plurality of main fiber optic cables between said fiber optic connector and said umbrella connector, permanently installed on a structure.

12. A method of decorating a structure, comprising:
Providing the structure:
Providing a fiber optic lighting system including an illuminator for emitting light, a plurality of main fiber optic cables having a first end and an opposite second end, each said first end connected to said illuminator, a corresponding plurality of umbrella connectors wherein one said umbrella connector is connected to said second end of each said main fiber optic cable, a corresponding plurality of umbrella end fiber optic cables wherein said umbrella end fiber optic cable is connectable to said umbrella connector, so that when said illuminator emits light, said light travels through said plurality of main fiber optic cables to said plurality of the umbrella end fiber optic cables, attaching said main fiber optic cables and said umbrella connectors to structure; and, attaching a first umbrella end fiber optic cable to said umbrella connector.

13. The method according to claim 12, further including;
Providing a second umbrella end fiber optic cable;
Removing said first umbrella end fiber optic cable and attaching said second umbrella end fiber optic cable to said umbrella connector.

14. The method according to claim 12, further including:
Permanently attaching said main fiber optic cables with said umbrella connectors to the structure.
